(19) United States
(12) Patent Application Publication
(10) Pub. No.: US 2025/0161949 A1
(43) Pub. Date: May 22, 2025

(54) METHODS OF INSTALLATION AND SERVICE OF A MODULE IN A LABORATORY WORKSTATION

(71) Applicant: Beckman Coulter, Inc., Brea, CA (US)

(72) Inventors: Ryan Qualizza, Indianapolis, IN (US); Abraham Olson, Indianapolis, IN (US); Alexis Mesa, Indianapolis, IN (US); Robert J. Perry, Indianapolis, IN (US); Kathryn Rogers, Indianapolis, IN (US); Mark Sauerburger, Indianapolis, IN (US)

(21) Appl. No.: 18/832,178

(22) PCT Filed: Jan. 18, 2023
(86) PCT No.: PCT/US2023/010995

§ 371 Date: Jul. 23, 2024

Related U.S. Application Data
(60) Provisional application No. 63/302,293, filed on Jan. 24, 2022.
(60) Provisional application No. 63/315,293, filed on Mar. 1, 2022.

(51) Int. Cl. B01L 9/02

(52) U.S. Cl. CPC B01L 9/02; B01L 2200/025; B01L 2200/028; B01L 2200/12; B01L 2200/18

(57) ABSTRACT

A method of installing a module associated with a life sciences laboratory workstation includes positioning at least a portion of at least one rail to extend outside the laboratory workstation; disposing the module on the at least one rail at a first position that is at least partially outside of the laboratory workstation; moving the module from the first position to a second position within the laboratory workstation via the at least one rail positioned within the laboratory workstation; transferring the module from the at least one rail to an actuator platform located within the laboratory workstation; and causing the actuator platform to position the module at a predetermined position within the laboratory workstation.

### RELATED APPLICATIONS

The present patent application claims the priority benefit of U.S. Provisional Patent Application Ser. No. 63/315,293, filed Mar. 1, 2022 and U.S. Provisional Patent Application Ser. No. 63/302,293, filed Jan. 24, 2022 the content of each is hereby incorporated by reference in its entirety into this disclosure.

### BACKGROUND

Systems in life sciences laboratories may include laboratory workstations and various modules for performing laboratory functions such as, for example, testing, measuring, analyzing, reacting, and/or sorting. Such modules may require installation within the laboratory workstation. Additionally, or alternatively, the modules may have to be removed and/or reinstalled in the laboratory workstation for service and/or replacement. Modules for use in a laboratory workstation are often heavy and require multiple people to move the module relative to the laboratory workstation (e.g., for installation, service, replacement, or the like). Moreover, moving the module relative to the laboratory workstation may require the use of additional equipment, such as, for example, a cart, to help the personnel move the module, install the module the in the laboratory workstation, remove the module from the laboratory workstation, and/or service the module.

Embodiments of the invention address these installation and service challenges and other challenges, individually and collectively.

Further limitations and disadvantages of conventional approaches will become apparent to one of skill in the art, through comparison of such systems with some aspects of the present disclosure as set forth in the remainder of the present application with reference to the drawings.

### SUMMARY

The inventors have recognized the need for systems and methods to make installation and/or service of a module in a laboratory workstation easier, more efficient, and require less personnel. The claimed and described installation and service systems and methods enable a single field service engineer to install and/or remove a module in a laboratory workstation. Moreover, in some aspects, the systems and methods described herein enable the module to be serviced without having to be removed from the system. In some aspects, the claimed and described systems and methods include a combination of at least one rail and an actuator platform. This combination enables a single field service engineer to move the module relative to and within the laboratory workstation relatively easily and efficiently (e.g., as compared to conventional systems).

In an aspect, a method of installing a module associated with a life sciences laboratory workstation, the method comprises positioning at least a portion of at least one rail to extend outside the laboratory workstation; disposing the module on the at least one rail at a first position that is at least partially outside of the laboratory workstation; moving the module from the first position to a second position within the laboratory workstation via the at least one rail positioned within the laboratory workstation; transferring the module from the at least one rail to an actuator platform located within the laboratory workstation; and causing the actuator platform to position the module at a predetermined position within the laboratory workstation.

In an aspect, the at least one rail comprises a first portion and a second portion, wherein the first portion is coupled to the second portion and the further comprises causing the second portion to be oriented perpendicular to the first portion; and causing the second portion to contact a support surface. In another aspect, the at least one rail is positioned partially within the laboratory workstation and partially outside of the laboratory workstation. In yet another aspect, the method further comprises positioning the at least one rail within the laboratory workstation.

In an aspect, moving the module from the first position to the second position comprises rolling the module on the at least one rail via at least one wheel coupled to the module, sliding the module along a surface of the at least one rail, or fastening the module to a fastener of the at least one rail when the at least one rail is in an extended configuration and collapsing the at least one rail to a collapsed configuration.

In an aspect, the actuator platform comprises a linear actuator configured to raise or lower the module. In another aspect, transferring the module from the at least one rail to the actuator platform comprises causing the actuator platform to raise the module off the at least one rail. In yet another aspect, the method further comprises removing the at least one rail from the laboratory workstation. In a further aspect, the method comprises coupling the module to the laboratory workstation at the predetermined position.

In an aspect, causing the actuator platform to position the module at the predetermined position within the laboratory workstation comprises causing the actuator platform to lower the module to the predetermined position. In another aspect, coupling the module to the laboratory workstation at the predetermined position comprises coupling the module to a mounting frame of the laboratory workstation. In yet another aspect, the method comprises moving the actuator platform to a storage position, wherein the storage position is under the module when the module is positioned in the laboratory workstation at the predetermined position. In a further aspect, the method comprises contracting the at least one rail from an expanded configuration to a contracted storage configuration of the at least one rail, wherein the module is not disposed on the at least one rail when the at least one rail is in the contracted storage configuration.

In an aspect, the actuator platform remains in the laboratory workstation when the actuator platform is not in use. In another aspect, the actuator platform comprises one or more lift screws configured to raise or lower the actuator platform within the laboratory workstation, the method further comprising rotating the lift screws to cause the actuator platform to be raised or lowered. In yet another aspect, the actuator platform comprises at least two lift screws, the actuator platform further comprising a shaft and a gear box coupled to each of the two lift screws. In a further aspect, the actuator platform comprises at least one of a lead screw lift, a scissor lift, a hoist, a pulley, an elevator mechanism, or combinations thereof.

In an aspect, the actuator platform is operated using a drill. In another aspect, the at least one rail comprises two or more rails, wherein each of the two or more rails comprises a fastener configured to fasten to the module, and wherein each of the two or more rails are configured to have an extended configuration to position the module at the first position and a collapsed configuration to position the module at the second position. In yet another aspect, the two or more rails are configured to extend from the laboratory workstation at an angle relative to a horizontal plane. In a further aspect, the angle is less than about 10 degrees. In yet another aspect, the angle is about 5 degrees.

In an aspect, the method comprises fastening the module to the fastener at the first position when the two or more rails are in the extended configuration; and moving the two or more rails from the extended configuration to the collapsed configuration to translate the module from the first position to the second position. In another aspect, each rail of the two or more rails comprises at least a first pin and a second pin configured to maintain the module in a substantially horizontal position when the module moved from the first position to the second position via moving the two or more rails from the extended configuration to the collapsed configuration. In yet another aspect, the first pin is longer than the second pin.

In an aspect, the at least one rail comprises a first portion, a second portion, and a third portion. In another aspect, the first portion is coupled to the second portion via a first hinge mechanism and the second portion is coupled to the third portion via a second hinge mechanism. In yet another aspect, the second portion is configured to fold relative to the first portion via the first hinge mechanism and the third portion is configured to fold relative to the second portion via the second hinge mechanism. In a further aspect, at least a portion of the first portion is configured to be within the laboratory workstation and the second portion is configured to be outside of the laboratory workstation.

In an aspect, the second portion is configured to unfold relative to the first portion via the first hinge mechanism to substantially align with the first portion. In another aspect, the third portion is configured to unfold relative to the second portion via the second hinge mechanism to be substantially perpendicular to the second portion. In yet another aspect, the third portion is configured to support the second portion when the second portion is substantially aligned with the first portion. In a further aspect, the third portion is configured to at least partially support a first weight of the second portion of the at least one rail and a second weight of the module. In yet a further aspect, a length of the third portion is adjustable.

In an aspect, the method comprises placing the module on a cart. In another aspect, the at least one rail comprises at least a first rail and a second rail, and placing the module on the cart comprises aligning the module with a third rail and a fourth rail of the cart; and moving, via the third and fourth rails of the cart, the module onto the cart. In yet another aspect, the module comprises at least a first wheel and a second wheel, and aligning the module with the third and fourth rails comprises aligning the first wheel with the third rail and the second wheel with the fourth rail. In a further aspect, moving the module onto the cart comprises rolling the first wheel along the third rail and rolling the second wheel along the fourth rail. In yet another aspect, the method comprises positioning the cart with the module proximate the laboratory workstation.

In an aspect, two rails are coupled to the laboratory workstation. In another aspect, the laboratory workstation comprises a liquid handling apparatus. In yet another aspect, the module comprises a bioreactor.

In an aspect, a method of servicing a module associated with a life sciences laboratory workstation comprises positioning at least a portion of at least one rail to extend outside the laboratory workstation; causing an actuator platform located within the laboratory workstation to move the module from a predetermined position within the laboratory workstation and position the module relative to the at least one rail; transferring the module from the actuator platform to the at least one rail; moving the module from a first position within the laboratory workstation to a second position that is at least partially outside of the laboratory workstation via the at least one rail positioned within the laboratory workstation; and servicing the module.

In an aspect, the method further comprises moving the module from the second position to the first position via the at least one rail positioned within the laboratory workstation; transferring the module from the at least one rail to the actuator platform; and causing the actuator platform to position the module at the predetermined position within the laboratory workstation. In another aspect, the at least one rail comprises a first portion and a second portion, and the first portion is coupled to the second portion, and the method comprises causing the second portion to be oriented perpendicular to the first portion; and causing the second portion to contact a support surface. In yet another aspect, the at least one rail is positioned partially within the laboratory workstation and partially outside of the laboratory workstation. In a further aspect, the method comprises positioning the at least one rail within the laboratory workstation.

In an aspect, moving the module from the second position to the first position or from the first position to the second position comprises rolling the module on the at least one rail via at least one wheel coupled to the module, sliding the module along a surface of the at least one rail, or fastening the module to a fastener of the at least one rail and extending the at least one rail to an extended configuration or collapsing the at least one rail to a collapsed configuration. In another aspect, the actuator platform comprises a linear actuator configured to raise or lower the module. In yet another aspect, transferring the module from the actuator platform to the at least one rail comprises causing the actuator platform to lower the module onto the at least one rail. In a further aspect, the method comprises removing the at least one rail from the laboratory workstation.

In an aspect, the method further comprises coupling the module to the laboratory workstation at the predetermined position. In another aspect, causing the actuator platform to position the module at the predetermined position within the laboratory workstation comprises causing the actuator platform to lower the module to the predetermined position. In yet another aspect, coupling the module to the laboratory workstation at the predetermined position comprises coupling the module to a mounting frame of the laboratory workstation. In a further aspect, the method comprises moving the actuator platform to a storage position, wherein the storage position is under the module when the module is positioned in the laboratory workstation at the predetermined position.

In an aspect, the method comprises contracting the at least one rail from an expanded configuration to a contracted storage configuration of the at least one rail, wherein the module is not disposed on the at least one rail when the at least one rail is in the contracted storage configuration. In another aspect, the actuator platform remains in the laboratory workstation when the actuator platform is not in use. In yet another aspect, the actuator platform comprises one or more lift screws configured to raise or lower the actuator platform within the laboratory workstation, the method further comprising rotating the lift screws to cause the actuator platform to be raised or lowered. In a further aspect, the actuator platform comprises at least two lift screws, the actuator platform further comprising a shaft and a gear box coupled to each of the two lift screws.

In an aspect, the actuator platform comprises at least one of a lead screw lift, a scissor lift, a hoist, a pulley, an elevator mechanism, or combinations thereof. In another aspect, the actuator platform is operated using a drill. In yet another aspect the at least one rail comprises two or more rails, each of the two or more rails comprises a fastener configured to fasten to the module, and each of the two or more rails are configured to have an extended configuration to position the module at the second position and a collapsed configuration to position the module at the first position.

In an aspect, the two or more rails are configured to extend from the laboratory workstation at an angle relative to a horizontal plane. In another aspect, the angle is less than about 10 degrees. In yet another aspect, the angle is about 5 degrees. In a further aspect, the method comprises fastening the module to the fastener at the first position when the two or more rails are in the collapsed configuration; and moving the two or more rails from the collapsed configuration to the extended configuration to translate the module from the first position to the second position.

In an aspect, each rail of the two or more rails comprises at least a first pin and a second pin configured to maintain the module in a substantially horizontal position when the module moved from the first position to the second position via moving the two or more rails from the collapsed configuration to the extended configuration. In another aspect, the first pin is longer than the second pin. In yet another aspect, the at least one rail comprises a first portion, a second portion, and a third portion. In a further aspect, the first portion is coupled to the second portion via a first hinge mechanism and the second portion is coupled to the third portion via a second hinge mechanism.

In an aspect, the second portion is configured to fold relative to the first portion via the first hinge mechanism and the third portion is configured to fold relative to the second portion via the second hinge mechanism. In another aspect, at least a portion of the first portion is configured to be within the laboratory workstation and the second portion is configured to be outside of the laboratory workstation. In yet another aspect, the second portion is configured to unfold relative to the first portion via the first hinge mechanism to substantially align with the first portion. In a further aspect, the third portion is configured to unfold relative to the second portion via the second hinge mechanism to be substantially perpendicular to the second portion.

In an aspect, the third portion is configured to support the second portion when the second portion is substantially aligned with the first portion. In another aspect, the third portion is configured to at least partially support a first weight of the second portion of the at least one rail and a second weight of the module. In yet another aspect, a length of the third portion is adjustable.

In an aspect, the laboratory workstation comprises a liquid handling apparatus. In another aspect, the module comprises a bioreactor.

In an aspect, a system for moving a module relative to a life sciences laboratory workstation comprises the laboratory workstation; at least one rail positioned at least partially within the laboratory workstation and extends outside of the laboratory workstation; the module, wherein the module is configured to move from a first position at least partially outside of the laboratory workstation to a second position within the laboratory workstation via the at least one rail; and an actuator platform within the laboratory workstation, wherein the actuator platform is configured to position the module at a predetermined position within the laboratory workstation.

In an aspect, the at least one rail comprises a first portion; and a second portion coupled to the first portion, wherein the second portion is configured to be oriented perpendicular to the first portion and to contact a support surface. In another aspect, the module is configured to roll on the at least one rail via at least one wheel coupled to the module from the first position to the second position, slide along a surface of the at least one rail from the first position to the second position, or fasten to a fastener of the at least one rail when the at least one rail is in an extended configuration and translate from the first position to the second position when the at least one rail is moved from the extended configuration to a collapsed configuration. In yet another aspect, the actuator platform comprises a linear actuator configured to raise or lower the module. In a further aspect, the actuator platform is configured to raise the module off the at least one rail.

In an aspect, the at least one rail is removable from the laboratory workstation. In another aspect, the module is configured to be coupled to the laboratory workstation at the predetermined position. In yet another aspect, the actuator platform is configured to lower the module to the predetermined position. In a further aspect, the module is configured to be coupled to a mounting frame of the laboratory workstation at the predetermined position.

In an aspect, the actuator platform is configured to be positioned in a storage position under the module when the module is positioned in the laboratory workstation at the predetermined position. In another aspect, the at least one rail is configured to contract from an expanded configuration to a contracted storage configuration when the module is at the predetermined position. In yet another aspect, the actuator platform remains in the laboratory workstation when the actuator platform is not in use. In a further aspect, the actuator platform comprises one or more lift screws configured to raise or lower the actuator platform within the laboratory workstation, wherein the lift screws are configured to be rotated to cause the actuator platform to be raised or lowered.

In an aspect, the actuator platform comprises at least two lift screws, the actuator platform further comprising a shaft and a gear box coupled to each of the two lift screws. In another aspect, the actuator platform comprises at least one of a lead screw lift, a scissor lift, a hoist, a pulley, an elevator mechanism, or combinations thereof. In yet another aspect, the actuator platform is operated using a drill. In a further aspect, the at least one rail comprises two or more rails, wherein each of the two or more rails comprises a fastener configured to fasten to the module, and wherein each of the two or more rails are configured to have an extended configuration to position the module at the first position and a collapsed configuration to position the module at the second position.

In an aspect, the two or more rails are configured to extend from the laboratory workstation at an angle relative to a horizontal plane. In another aspect, the angle is less than about 10 degrees. In yet another aspect, the angle is about 5 degrees. In a further aspect, the module is configured to be fastened to the fastener at the first position when the two or more rails are in the extended configuration, and wherein the two or more rails are configured to move from the extended configuration to the collapsed configuration to translate the module from the first position to the second position.

In an aspect, each rail of the two or more rails comprises at least a first pin and a second pin configured to maintain the module in a substantially horizontal position when the module moved from the first position to the second position via moving the two or more rails from the extended configuration to the collapsed configuration. In another aspect, the first pin is longer than the second pin. In yet another aspect, the at least one rail comprises a first portion, a second portion, and a third portion. In a further aspect, the first portion is coupled to the second portion via a first hinge mechanism and the second portion is coupled to the third portion via a second hinge mechanism.

In an aspect, the second portion is configured to fold relative to the first portion via the first hinge mechanism and the third portion is configured to fold relative to the second portion via the second hinge mechanism. In another aspect, at least a portion of the first portion is configured to be within the laboratory workstation and the second portion is configured to be outside of the laboratory workstation. In yet another aspect, the second portion is configured to unfold relative to the first portion via the first hinge mechanism to substantially align with the first portion. In a further aspect, the third portion is configured to unfold relative to the second portion via the second hinge mechanism to be substantially perpendicular to the second portion.

In an aspect, the third portion is configured to support the second portion when the second portion is substantially aligned with the first portion. In another aspect, the third portion is configured to at least partially support a first weight of the second portion of the at least one rail and a second weight of the module. In yet another aspect, a length of the third portion is adjustable.

In an aspect, the system comprises a cart configured to position the module relative to the at least one rail outside of the laboratory workstation. In another aspect, the at least one rail comprises at least a first rail and a second rail, and the cart comprises a third rail configured to align with the first rail and receive a first wheel coupled to the module; and a fourth rail configured to align with the second rail and receive a second wheel coupled to the module. In yet another aspect, the first wheel is configured to be rolled along the third rail of the cart and along the first rail into the laboratory workstation when the third rail is aligned with the first rail; and the second wheel is configured to be rolled along the fourth rail of the cart and along the second rail into the laboratory workstation when the fourth rail is aligned with the second rail.

In an aspect, the laboratory workstation comprises a liquid handler workstation. In another aspect, the module comprises a bioreactor module.

### BRIEF DESCRIPTION OF THE DRAWINGS

FIG. 1 is a perspective view of a system for moving a module relative to a life sciences laboratory workstation, in accordance with aspects of the disclosure.

FIGS. 2A-2D are perspective views of different configurations of the at least one rail of the system, in accordance with aspects of the disclosure. FIG. 2A is the at least one rail including a first portion; FIG. 2B is the at least one rail including a first portion and a second portion; FIG. 2C is the at least one rail including a first portion, a second portion, and a third portion; and FIG. 2D is the at least one rail configured to extend to an extended configuration and collapse to a collapsed configuration.

FIGS. 3A-3F illustrate one aspect of the at least one rail of the system of FIG. 1 in which each rail is configured to extend to an extended configuration at an angle relative to a horizontal plane and collapse to a collapsed configuration, in accordance with aspects of the disclosure.

FIG. 4 is a flow diagram illustrating a method of installing a module in a life sciences laboratory workstation, in accordance with aspects of the disclosure.

FIG. 5 is a flow diagram illustrating a method of servicing a module of a life sciences laboratory workstation, in accordance with aspects of the disclosure.

### DETAILED DESCRIPTION

It is to be understood that this disclosure is not limited to the particular methodology, protocols, and reagents described herein and as such may vary. It is also to be understood that the terminology used herein is for the purpose of describing particular aspects only and is not intended to limit the scope of the present disclosure or the appended claims.

As used herein and in the appended claims, the singular forms “a,” “an,” and “the” include plural reference unless the context clearly indicates otherwise. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting aspects, examples, instances, or illustrations. Unless defined otherwise, all technical and scientific terms used herein have the same meaning as commonly understood to one of ordinary skill in the art to which this disclosure belongs.

Life sciences laboratory workstations may include various modules for performing laboratory functions such as, for example, testing, measuring, analyzing, reacting, and/or sorting. These modules may have to be installed in the laboratory workstation and/or removed from the laboratory workstation. For example, the modules may have to be periodically removed and reinstalled for service, replacement, or the like. In conventional systems including a laboratory workstation and a module, the module has to be manually lifted into and out of the laboratory workstation for installation and service procedures. In many cases, modules for a laboratory workstation may be too heavy for one, two, or even three field service engineers (or other personnel) to safely lift, install, and/or remove. Conventional systems may also require a cart on site to assist the field service engineers in installing and servicing the module of the laboratory workstation. For example, servicing a conventional system may require lifting and removing the module from the laboratory workstation and placing the module on a cart for transportation to a service area and/or for servicing the module while on the cart. In such examples, the cart needs to be stored on site after installation in case the module requires servicing. Not only does storage of the cart take up space in the laboratory, but the cart may leak, require servicing itself, become damaged, be misplaced, or be disposed of.

The systems and methods including at least one rail disclosed herein enable a single operator to install, remove, and/or service a module of a laboratory workstation. Moreover, after an initial installation use of a cart (or other similar mechanism) future servicing is optional with the methods and systems described herein. For example, the module may be able to remain on the at least one rail for servicing rather than having to be lifted onto a cart. In this way, use of the systems and methods including the at least one rail disclosed herein makes installation and/or service of a module easier, more efficient, and require less personnel.

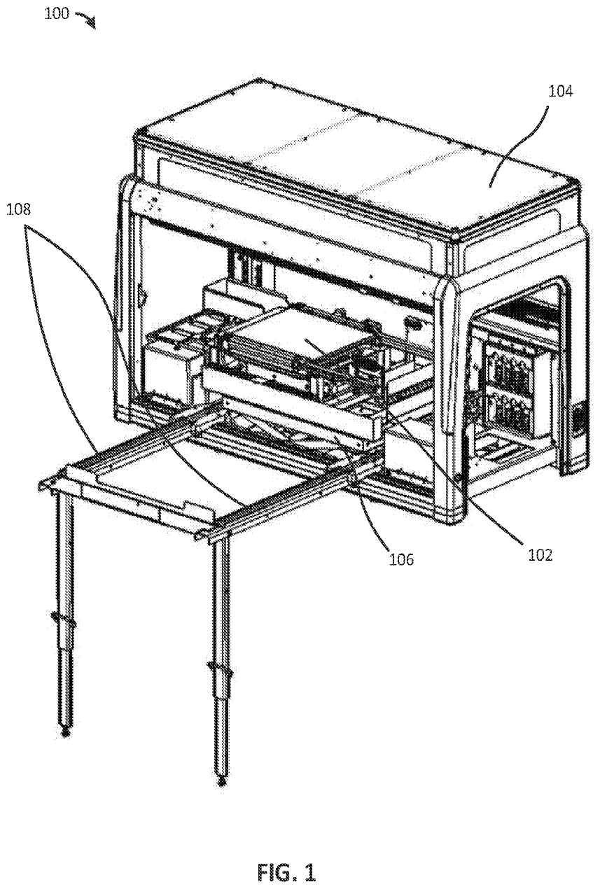

FIG. 1 is a perspective view of a system 100 for moving a module 102 relative to a life sciences laboratory workstation 104. The system 100 includes the laboratory workstation 104. The laboratory workstation 104 may include any suitable life sciences laboratory workstation 104, such as, for example, a liquid handler workstation, a cell cultivation workstation, or a cell analysis workstation. In some aspects, the laboratory workstation 104 includes a workstation bench, table, counter, or another support structure. For example, the laboratory workstation 104 may be a liquid handler workstation (or another laboratory workstation) on top of a workstation bench.

The laboratory workstation 104 includes one or more modules 102. The module 102 may include any suitable module. In some aspects, the module 102 includes one or more of a bioreactor module, a cell analysis module, a media analysis module, a sample analysis module, a protein titer measurement module, a cell viability module, a flow cytometry module, a cell sorter, a particle sorter, a cell counter, a particle counter, a mass spectrometer, or a liquid chromatography module. The system 100 can include any combination of a laboratory workstation 104 and one or more modules 102. For example, the system 100 may include a laboratory workstation 104 that is a liquid handler workstation and the module 102 may include a bioreactor. As another example, the system 100 may include a laboratory workstation 104 that is a cell analysis workstation and the module 102 may include a cell analysis module. In other aspects, the system 100 may include a different combination of a laboratory workstation 104 and a module 102, additional or alternative modules, or may include a laboratory workstation and/or module not described herein.

The module 102 is configured to be positioned at a predetermined position within the laboratory workstation 104. For example, the laboratory workstation 104 may include a mounting frame at the predetermined position within the laboratory workstation 104 that the module 102 is configured to be coupled to and/or be placed on. In other aspects, the module 102 may be configured to be positioned at the predetermined position within the laboratory workstation 104 in a different manner.

In some aspects, the module 102 includes one or more wheels coupled to the module 102, or the module 102 may be releasably coupleable to wheels. In other aspects, the module 102 may be configured to be on top of a wheeled structure (e.g., a cart). In aspects in which the module includes one or more wheels or is on top of a wheeled structure, it may be easier to move the module 102 relative to the laboratory workstation 104 (e.g., into and/or out of the laboratory workstation 104). In other aspects, the module 102 may not include wheels or be on a structure with wheels.

The system 100 further includes an actuator platform 106. The actuator platform 106 is within the laboratory workstation 104. In examples in which the laboratory workstation 104 includes a workstation bench or another support structure, the actuator platform 106 may be on top of the workstation bench or support structure. The actuator platform 106 is configured to move the module 102 within the laboratory workstation 104. For example, the actuator platform 106 is configured to raise or lower the module 102 within the laboratory workstation 104. The actuator platform 106 is configured to move the module 102 to the predetermined position within the laboratory workstation 104. In some aspects, the actuator platform 106 is configured to lower the module 102 to the predetermined position. For example, the actuator platform 106 may lower the module 102 to a mounting frame at the predetermined position. Additionally, or alternatively, the actuator platform 106 may be configured to raise and/or lower the module relative to at least one rail 108. For example, the actuator platform 106 may be configured to raise the module 102 off the at least one rail 108 and/or lower the module 102 onto the at least one rail 108.

In some aspects, the actuator platform 106 may include a linear actuator platform, a rotary actuator platform, or the like. In aspects in which the actuator platform 106 includes a linear actuator platform, the linear actuator platform may be a lift configured to translate the module 102 vertically (e.g., raise and/or lower) and/or horizontally within the laboratory workstation 104. Additionally, or alternatively, the actuator platform 106 may include at least one of a lead screw lift, a scissor lift, a hoist, a pulley, an elevator mechanism, or combinations thereof. In some aspects, the actuator platform 106 may include one or more lift screws configured to raise or lower the actuator platform 106 within the laboratory workstation 104. In such aspects, the lift screws may be rotated to cause the actuator platform 106 to be raised or lowered. The actuator platform 106 may include at least two lift screws, a shaft, and a gear box coupled to each of the two lift screws. In some embodiments, the actuator platform 106 may be operated (e.g., raised, lowered, and/or moved horizontally) by rotating a screw mechanism of the actuator platform 106, e.g., by manual rotation using a hand tool, by using a drill, by using a rotary motor. For example, a drill may be used to turn an input shaft to the actuator platform 106 to move the actuator platform 106. In other embodiments, the actuator platform 106 may be operated by a linear motor, a pneumatic or hydraulic system, or any other suitable mechanism. In some aspects, the actuator platform 106 is configured to remain in the laboratory workstation 104 when the actuator platform 106 is not in use. In some such aspects, the actuator platform 106 may be configured to be positioned in a storage position under the module 102 when the module 102 is positioned in the laboratory workstation 104 at the predetermined position.

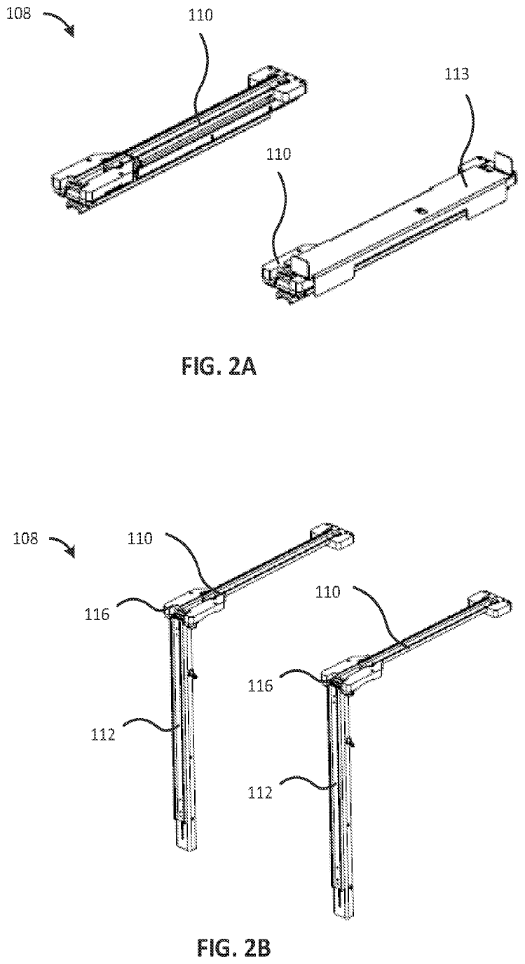

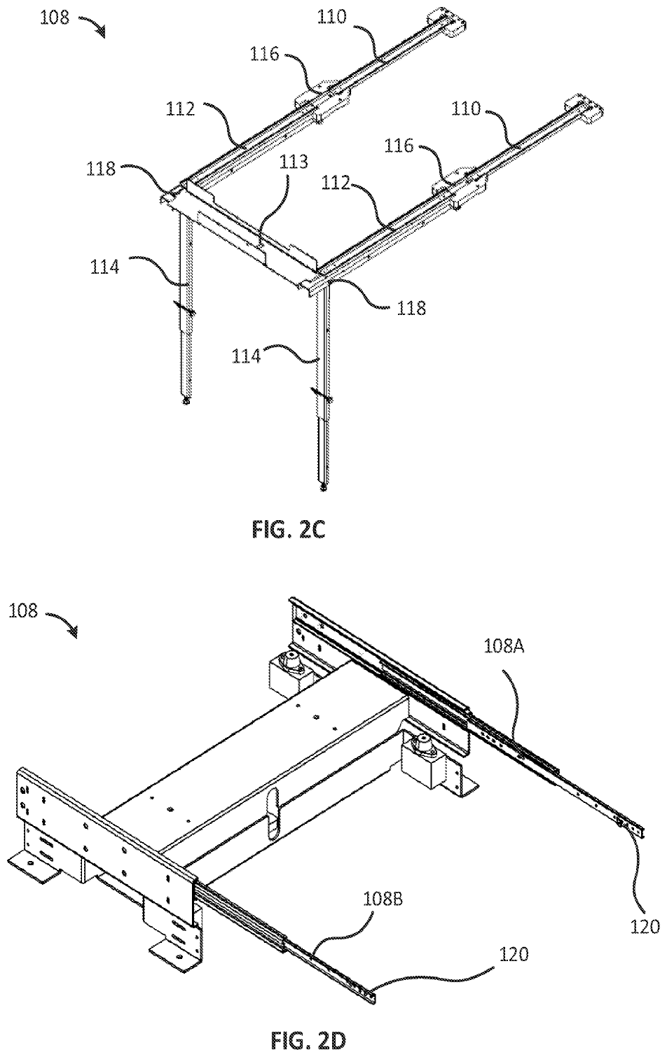

The system 100 also includes at least one rail 108. The system 100 illustrated in FIG. 1 includes two rails 108, but the system 100 may alternatively include one rail or three or more rails. The at least one rail 108 is positioned at least partially within the laboratory workstation 104 and extends outside of the laboratory workstation 104. In some examples, the at least one rail 108 may be removable from the laboratory workstation 104. In FIG. 1, the example system 100 is in a configuration where the module 102 is positioned within the laboratory workstation 104 and on to the actuator platform 106, prior to its final resting place in the predetermined position within the laboratory workstation 104. Different configurations of the at least one rail 108 will be described in more detail below with respect to FIGS. 2A-2D.

The module 102 is configured to move from a first position at least partially outside of the laboratory workstation 104 to a second position within the laboratory workstation 104 via the at least one rail 108. In some aspects, the module 102 may be configured to roll on the at least one rail 108 (e.g., via one or more wheels coupled to the module 102), slide along a surface of the at least one rail 108, and/or translate from the first position to the second position when the at least one rail 108 is moved from an extended configuration to a collapsed configuration (as described in more detail below). For example, the module 102 may be moved from the first position to the second position (or vice versa) via the at least one rail 108 for installation of the module 102 within the laboratory workstation 104 and/or for servicing of the module 102. Methods of installing the module 102 within the laboratory workstation 104 and servicing the module 102 are discussed in more detail below.

In some aspects, the system 100 further includes a cart configured to position the module 102 relative to the at least one rail 108 outside of the laboratory workstation 104. As discussed above, in some aspects, the module 102 may include one or more wheels coupled to the module 102. In some such aspects, the cart may include at least one rail. For example, in some aspects, the at least one rail 108 may include a first rail and a second rail and the cart may include a third rail and a fourth rail. In such aspects, the third rail of the cart may be configured to align with the first rail of the at least one rail 108 and the fourth rail of the cart may be configured to align with the second rail of the at least one rail 108. In this way, the first and third rails may be configured to receive a first wheel coupled to the module 102 and the second and fourth rails may be configured to receive a second wheel coupled to the module 102. Such a configuration may enable the module 102 to be rolled along the third and fourth rails of the cart and transferred onto the first and second rails of the at least one rail 108 to move the module 102 from the first position to the second position within the laboratory workstation 104. In other aspects, the cart may not include the third and fourth rails. For example, the cart may not include any rails. In such aspects, the module 102 may be configured to roll on top of a surface of the cart and/or be placed on the cart to be fastened to, slid on, or other disposed on the at least one rail 108.

FIGS. 2A-2D are perspective views of different configurations of the at least one rail 108 of the system 100. Although illustrated as separate aspects, the configurations illustrated in FIGS. 2A-2D can be combined or used together in the system 100. Moreover, although the aspects of the at least one rail 108 of the system of FIG. 1 illustrated in FIGS. 2A-2D each include two rails 108, in other aspects the at least one rail 108 may include a single rail or three or more rails. FIG. 2A is the at least one rail 108 of the system of FIG. 1 including a first portion 110. Each rail 108 of the at least one rail 108 includes a first portion 110. The first portion 110 is configured to be positioned at least partially within the laboratory workstation 104 and extend outside of the laboratory workstation 104. In some aspects, the module 102 is configured to roll on the first portion 110 of the at least one rail 108 to move from the first position to the second position. In some aspects, FIG. 2A illustrates an example of the at least one rail 108 in a contracted storage configuration. For example, the at least one rail 108 in the contracted storage configuration may be configured to remain in the module 102 when not in use. In other examples, the at least one rail 108 may be removed from the module 102 for storage. In such aspects, when the at least one rail 108 is stored in the contracted storage configuration, the at least one rail 108 may take up less space (e.g., have a smaller footprint) than a rail that is not configured to contract to a contracted storage configuration. Additionally, or alternatively, the at least one rail 108 may include a lock bar 113. For example, as illustrated in FIG. 2A, the lock bar 113 may disposed on top of one of the rails 108 when the at least one rail 108 is in the contracted storage configuration. The lock bar 113 may be used to support the at least one rail 108 when the at least one rail 108 is in the expanded configuration (as discussed in more detail below).

FIG. 2B is the at least one rail 108 of the system of FIG. 1 including a first portion 110 and a second portion 112. The first portion 110 of the at least one rail 108 illustrated in FIG. 2B may be the same or substantially similar to the first portion 110 of the at least one rail illustrated in FIG. 2A. For example, the module 102 may be configured to roll on the first portion 110 of the at least one rail 108 to move from the first position to the second position. The at least one rail 108 illustrated in FIG. 2B further includes a second portion 112. In some aspects, the second portion 112 is coupled to the first portion 110 via a first hinge mechanism 116. In such aspects, the first hinge mechanism 116 enables the first portion 110 and the second portion 112 to pivot relative to the other of the second portion 112 or first portion 110. In some aspects, the second portion 112 may be configured to fold relative to the first portion 110 (or vice versa). For example, the second portion 112 may be configured to fold relative to the first portion 110 such that the first portion 110 and the second portion 112 are substantially parallel to each other. For example, the second portion 112 may fold relative to the first portion 110 to be put into the contracted storage configuration discussed above with respect to FIG. 2A. In some such aspects, the at least one rail 108 may have a relatively small footprint (e.g., for storage) as compared to rails 108 with portions that are not configured to fold relative to each other. In other aspects, the first portion 110 may be coupled to the second portion 112 in a different manner. For example, in some aspects, the first portion 110 may not be pivotable relative to the second portion 112 (or vice versa). For example, the first portion 110 may be fixedly coupled to the second portion 112 by a removable pin or other fastener, a friction fit, a snap fit, a clamp, or any other suitable coupling mechanism. In some aspects, the second portion 112 may be detached from the first portion, for example, by removing a coupling mechanism (e.g., by removing a pin used to couple the portions).

In some aspects, the second portion 112 is configured to be oriented perpendicular to the first portion 110 and contact a support surface (e.g., a ground, a table, a cart, or the like). The second portion 112 may be configured to support a first weight of the first portion 110 and a second weight of the module 102. In this way, the second portion 112 may support at least the portion of the first portion 110 that extends outside of the laboratory workstation 104 and the module 102 (e.g., when the module 102 is on or coupled to the at least one rail 108). In some such aspects, the support provided the second portion 112 may enable the first portion 110 to extend further outside of the laboratory workstation 104 and/or allow the at least one rail 108 to be used with a module 102 that is relatively heavy (e.g., as compared to the at least one rail without a second portion and/or a system not including the at least one rail 108 described herein). In some aspects, a length of the second portion 112 may be adjustable. In turn, the second portion 112 may be able to contact support surfaces different distances from the perpendicular first portion 110 (e.g., a ground compared to a table).

FIG. 2C is the at least one rail 108 of the system of FIG. 1 including a first portion 110, a second portion 112, and a third portion 114. The first portion 110 and/or the second portion 112 of the at least one rail 108 of FIG. 2C may be similar to the first portion 110 and/or the second portion 112 of the at least one rail 108 of FIG. 2B. For example, the second portion 112 may be coupled to the first portion 110 via a first hinge mechanism 116 such that the first portion 110 and the second portion 112 are pivotable relative to each other. The at least one rail 108 of FIG. 2C further includes a third portion 114. The third portion 114 may be coupled to the second portion 112 via a second hinge mechanism 118. In such aspects, the second hinge mechanism 118 enables the second portion 112 and the third portion 114 to pivot relative to the other of the third portion 114 or second portion 112. In some aspects, the third portion 114 may be configured to fold relative to the second portion 112. Additionally, or alternatively, the second portion 112 may be configured to fold relative to the first portion 110 (or vice versa). For example, the third portion 114 may be configured to fold relative to the second portion 112 such that the third portion 114 and the second portion 112 are substantially parallel to each other and/or the second portion 112 may be configured to fold relative to the first portion 110 such that the first portion 110 and the second portion 112 are substantially parallel to each other. For example, the second portion 112 may fold relative to the first portion 110 and the third portion 114 may fold relative to the second portion 112 to be put into the contracted storage configuration discussed above with respect to FIG. 2A. In some such aspects, the at least one rail 108 may have a relatively small footprint (e.g., for storage) as compared to rails 108 with portions that are not configured to fold relative to each other. In other aspects, the first portion 110, second portion 112, and/or third portion 114 may be coupled to each other in a different manner. The configuration of FIG. 2C allows for further extension of the rail on which the module 102 can rest, and thus allows the module 102 to be expanded further outward from the laboratory workstation 104. This may be particularly advantageous in the case of servicing or inspection (i.e., after the initial installation), because it can allow a technician more access to the module 102.

In some aspects, the at least one rail 108 illustrated in FIG. 2C is in an expanded configuration. In some such aspects, at least a portion of the first portion 110 may be configured to be within the laboratory workstation 104 and the second portion 112 may be configured to be outside of the laboratory workstation 104 (when the at least one rail 108 is positioned at least partially within the laboratory workstation 104). In some aspects, the second portion 112 is configured to unfold relative to the first portion 110 via the first hinge mechanism 116 to substantially align with the first portion 110. In this way, the first and second portions 110, 112 may define a substantially continuous rail extending from outside of the laboratory workstation 104 to at least partially within the laboratory workstation 104. In some such examples, the module 102 may be configured to roll (e.g., using one or more wheels coupled to the module 102) from the first position to the second position along the second portion 112 and the first portion 110. Additionally, or alternatively, when the at least one rail 108 is in the expanded configuration, the third portion 114 may be configured to be oriented perpendicular to the second portion 110 and contact a support surface (e.g., a ground, a table, a cart, or the like). The third portion 114 may be configured to support the second portion 112 when the second portion 112 is substantially aligned with the first portion 110. For example, the third portion 114 may be configured to support the first weight of the first portion 110, the second weight of the module 102, and/or a third weight of the second portion 112. In some examples, the lock bar 113 may also be configured to unfold or couple to the second portion 112 and/or the third portion 114. The lock bar 113 may provide additional support and/or strengthen the at least one rail 108 when the at least one rail 108 is in the expanded configuration. In this way, the at least one rail 108 in the expanded configuration including the lock bar 113 may enable the at least one rail 108 to support the weight of a heavier module 102 in comparison to rails that do not include the lock bar 113. In other examples, the at least one rail 108 may not include the lock bar 113. In some aspects, a length of the third portion 114 may be adjustable. In turn, the third portion 114 may be able to contact support surfaces different distances from the perpendicular second portion 112 and/or first portion 110 (e.g., a ground compared to a table).

FIG. 2D illustrates an alternative embodiment of the at least one rail 108 of the system 100 of FIG. 1, where each rail 108 is configured to extend to an extended configuration and collapse to a collapsed configuration. The at least one rail 108 may be configured to extend and collapse in any suitable manner. For example, the at least one rail 108 may be extend and collapse similar to a drawer using telescoping rails. In other aspects, the at least one rail 108 may extend and collapse in a different manner. FIG. 2D illustrates the at least one rail 108 in the extended configuration. In some aspects, the at least one rail 108 is configured to translate from the first position to the second position when the at least one rail 108 is moved from the extended configuration to the collapsed configuration. For example, each rail 108A, 108B may be at least partially outside of the laboratory workstation 104 in the extended configuration and at least partially within the laboratory workstation 104 in the collapsed configuration. In some aspects, as illustrated in FIG. 2D, the rails 108A, 108B may be configured to extend from the laboratory workstation 104 substantially parallel to a horizontal plane. In other aspects, and as discussed in more detail below, the rails 108A, 108B may be configured to extend from the laboratory workstation 104 at an angle relative to the horizontal plane.

In some aspects, each rail 108A, 108B includes a fastener 120 (e.g., a hook, a clamp, a snap) configured to fasten to the module 102. For example, referencing FIG. 2D, the module 102 may be configured to be fastened to the fastener 120 at the first position when the rails 108 are in the extended configuration. The module 102 may be translated from the first position to the second position by moving the rails 108 from the extended configuration to the collapsed configuration. In some aspects, the module 102 may be unfastened from the fasteners 120 to be moved to the predetermined position in the laboratory workstation 104. In some aspects, the rails 108A, 108B may be fully within the laboratory workstation 104 when in the collapsed configuration. In such aspects, the at least one rail 108 may be stored in the collapsed configuration in the laboratory workstation 104 when the module 102 is in the predetermined position in the laboratory workstation 104. In other examples, the at least one rail 108 may be removed from the laboratory workstation 104 for storage or may be stored in a different manner.

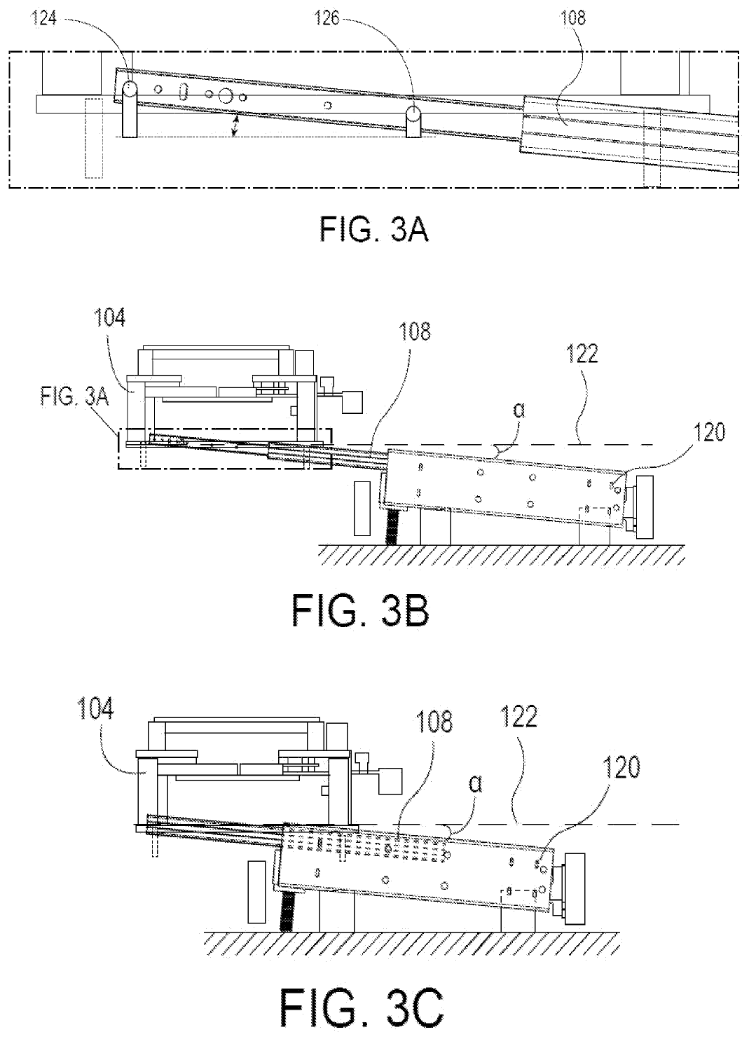

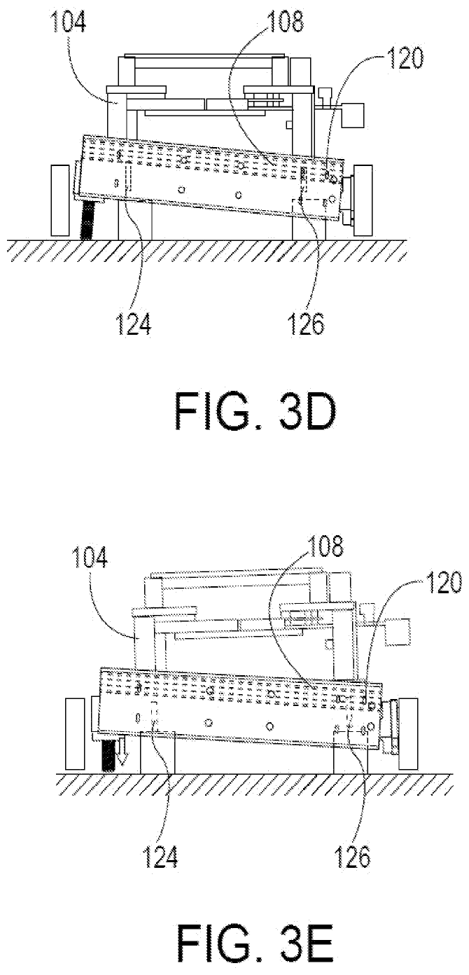

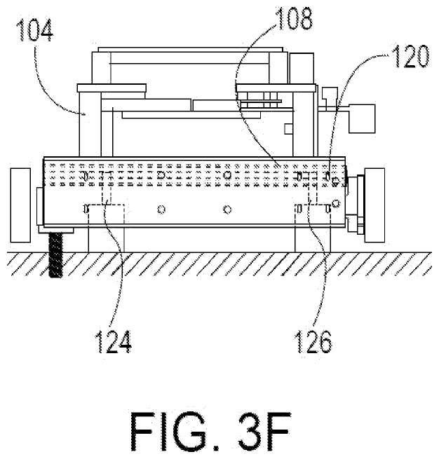

FIGS. 3A-3F illustrate one aspect of the at least one rail 108 of the system 100 of FIG. 1 in which each rail is configured to extend to an extended configuration at an angle α relative to a horizontal plane 122 and collapse to a collapsed configuration. FIG. 3A illustrates a enlarged view of the at least one rail 108 configured to extend to an extended configuration at an angle α relative to a horizontal plane 122 and collapse to a collapsed configuration. FIG. 3B illustrates the at least one rail 108 in the extended configuration at the angle α relative to the horizontal plane 122. FIG. 3F illustrates the at least one rail 108 in the collapsed configuration. FIGS. 3C-3E illustrate the at least one rail 108 transitioning between the extended configuration of FIG. 3B and the collapsed configuration of FIG. 3F.

In some aspects, the at least one rail 108 is configured to extend at a decline relative to the horizontal plane. In some aspects, the angle α may be less than about 10 degrees. For example, the angle α may be about 5 degrees in some aspects. In some aspects, each rail of the at least one rail 108 includes a first pin 124 and a second pin 126 configured to maintain the module 102 in a substantially horizontal position when the module 102 moved from the first position to the second position via moving the two or more rails 108 from the extended configuration to the collapsed configuration. For example, the first pin 124 may be longer than the second pin 126 to account for the angle α and keep the module 102 substantially horizontal when moving from the first position to the second position via the at least one rail 108. In some aspects, the first pin 124 and the second pin 126 may configure the at least one rail 108 to be substantially horizontal while in the collapsed configuration.

In other aspects, the first pin 124 and the second pin 126 may be the same length. In some such aspects, each rail of the at least one rail 108 may include two or more slots configured to couple to the module 102. For example, the two or more slots of each rail 108 may be configured to couple to a fastening mechanism of the module 102. In some such aspects, each of the two or more slots on each rail 108 may be different sizes (e.g., lengths) and/or offset from each other. In some aspects, the different sizes and/or offset positioning of the two or more slots may correspond to the angle α. In this way, when the module 102 is coupled to the at least one rail 108 via the slots of the rails 108, the module 102 may be maintained in a substantially horizontal position when moving from the first position to the second position via the at least one rail 108. In other aspects, the module 102 may be maintained in a substantially horizontal position in another way or may not be configured to be maintained in a substantially horizontal position.

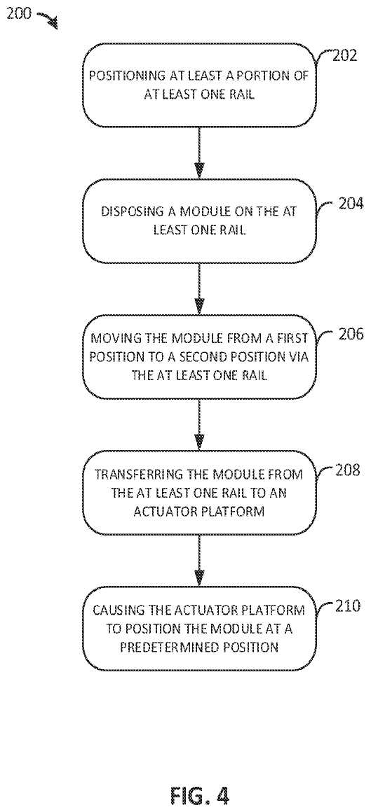

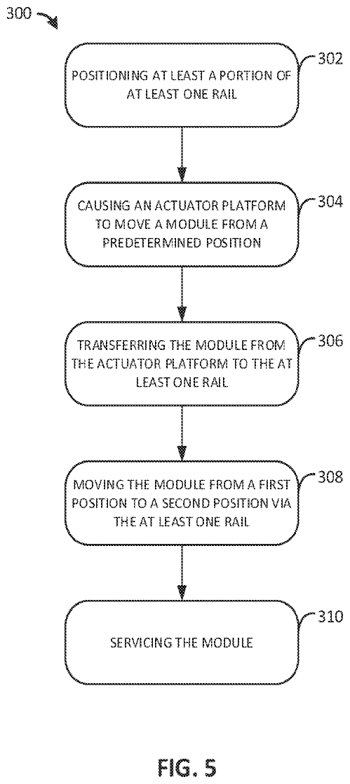

FIG. 4 is a flow diagram illustrating a method 200 of installing a module 102 in a life sciences laboratory workstation 104. The method 200 of FIG. 4 will be described with respect the aspects of the system 100 of FIG. 1. However, the method 200 of FIG. 4 can be used with additional or alternative aspects in accordance with the aspects of the disclosure. The method 200 includes positioning at least a portion of at least one rail 108 to extend outside of the laboratory workstation 104 (202). In some examples, the at least one rail 108 may be positioned partially within the laboratory workstation 104 and partially outside the laboratory workstation 104. In some such aspects, the method 200 may further include positioning the at least one rail 108 within the laboratory workstation 104. As discussed above, in some aspects the at least one rail 108 may include a first portion 110 and a second portion 112. In such aspects, the method 200 may include causing the second portion 112 to be oriented perpendicular to the first portion 110 and causing the second portion 112 to contact a support surface (e.g., as illustrated in FIG. 2B). In aspects in which the at least one rail 108 includes three portions, the method 200 may include causing the second portion 112 to substantially align with the first portion 110, causing the third portion 114 to be oriented perpendicular to the second portion 112, and causing the third portion 114 to contact a support surface (e.g., as illustrated in FIG. 2C).

The method 200 further includes disposing the module 102 on the at least one rail 108 at a first position that is at least partially outside of the laboratory workstation 104 (204). In some aspects, disposing the module 102 on the at least one rail 108 includes placing at least one wheel coupled to the module 102 on the at least one rail 108, placing the module 102 on the at least one rail 108, and/or fastening the module 102 to a fastener 120 of the least one rail 108 when the at least one rail 108 is in an extended configuration. In other aspects, the module 102 may be disposed on the at least one rail 108 in a different way.

In some aspects, a cart may be optionally used in the method 200 to position the module 102 proximate to the laboratory workstation 104. In some such aspects, the method 200 may include placing the module 102 on the cart. In aspects in which the at least one rail 108 includes a first rail and a second rail and the cart includes a third rail and fourth rail configured to align with the first and second rails, respectively, placing the module 102 on the cart may include aligning the module 102 with the third rail and fourth rail of the cart and moving, via the third and fourth rails, the module 102 onto the cart. In some aspects, such as those in which the module 102 includes one or more wheels, aligning the module 102 with the third and fourth rails includes aligning a first wheel coupled to the module 102 with the third rail and aligning a second wheel coupled to the module 102 with the fourth rail. In this way, moving the module 102 onto the cart may include rolling the first wheel along the third rail and rolling the second wheel along the fourth rail. The method 200 may also include positioning the cart proximate the laboratory workstation 104. In some such aspects, positioning the cart proximate the laboratory workstation 104 may include positioning the module 102 at the first position while the module 102 is on the cart

The method 200 includes moving the module 102 from the first position to a second position within the laboratory workstation 104 via the at least one rail 108 positioned within the laboratory workstation 104 (206). In some aspects, moving the module 102 from the first position to a second position within the laboratory workstation 104 via the at least one rail 108 positioned within the laboratory workstation 104 includes rolling the module 102 on the at least one rail 108 via at least one wheel coupled to the module 102. In other aspects, moving the module 102 from the first position to a second position within the laboratory workstation 104 via the at least one rail 108 positioned within the laboratory workstation 104 includes sliding the module 102 along a surface of the at least one rail 108. In yet other aspects, moving the module 102 from the first position to a second position within the laboratory workstation 104 via the at least one rail 108 positioned within the laboratory workstation 104 includes fastening the module 102 to a fastener 120 of the at least one rail 108 when the at least one rail 108 is in the extended configuration and collapsing the at least one rail 108 to a collapsed configuration. For example, the method 200 may include fastening the module to the fastener 120 at the first position when the at least one rail 108 is in the extended configuration and moving the at least one rail 108 from the extended configuration to the collapsed configuration to translate the module 102 from the first position to the second position. In some aspects, moving the module 102 from the first position to the second position may include a combination of the aspects described herein or may be moved from the first position to the second position in a different manner.

The method 200 further includes transferring the module 102 from the at least one rail 108 to an actuator platform 106 (208). In some aspects, transferring the module 102 from the at least one rail 108 to the actuator platform 106 may include causing the actuator platform 106 to raise the module off the at least one rail 108. In other aspects, transferring the module 102 from the at least one rail 108 to the actuator platform 106 may be done in a different way. For example, transferring the module 102 may include unfastening the module 102 from the fastener 120 at the second position and moving the module 102 onto the actuator platform 106.

The method 200 includes causing the actuator platform 106 to position the module 102 at the predetermined position within the laboratory workstation 104 (210). In some aspects, causing the actuator platform 106 to position the module 102 at the predetermined position within the laboratory workstation 104 includes causing the actuator platform 106 to lower the module 102 to the predetermined position. For example, the causing the actuator platform 106 to position the module 102 at the predetermined position may include causing the actuator platform 106 to lower the module 102 onto a mounting frame at the predetermined position. In some aspects, causing the actuator platform 106 to position the module 102 at the predetermined position may include rotating a screw mechanism of the actuator platform 106 (e.g., by manual rotation using a hand tool, by using a drill, by using a rotary motor) to cause the actuator platform 106 to raise and/or lower the actuator platform 106. Any other suitable mechanism may be used to raise or lower the actuator platform 106 (e.g., a linear motor, a pneumatic or hydraulic system). In some aspects, the method 200 may include coupling the module 102 to the laboratory workstation 104 at the predetermined position. For example, the method 200 may include coupling the module 102 to a mounting frame of the laboratory workstation 104.

In some examples, the method 200 includes storing one or both of the at least one rail 108 and/or the actuator platform 106. For example, the method 200 may include uncoupling the at least one rail 108 from the laboratory workstation 104 and storing it in a suitable location (e.g., within the workstation bench of the laboratory workstation 104, at a designated space within the laboratory workstation 104, some other location outside the laboratory workstation 104). In other aspects, the method 200 may include contracting the at least one rail 108 from an expanded configuration to a contracted storage configuration of the at least one rail 108. FIG. 2A illustrates an example of the at least one rail 108 in the contracted storage configuration. FIG. 2A illustrates an example, where the lock bar 113 is disposed on top of one of the rails in the contracted storage configuration. In some such aspects, the module 102 may not be disposed on the at least one rail 108 when the at least one rail 108 is in the contracted storage configuration. For example, the module 102 may be at the predetermined position within the laboratory workstation 104 when the at least one rail 108 is in the collapsed storage position. In yet other aspects, one or more portions of the at least one rail 108 may be folded relative to another one or more portions of the at least one rail 108 for storage. Additionally, or alternatively, the method 200 may include moving the actuator platform 106 to a storage position. In some such aspects, the storage position may be under the module 102 when the module 102 is in the laboratory workstation 104 at the predetermined position. In some aspects, the actuator platform 106 remains in the laboratory workstation 104 when the actuator platform 106 is not in use.

FIG. 5 is a flow diagram illustrating a method 300 of servicing a module 102 of a life sciences laboratory workstation 104. The method 300 of FIG. 5 will be described with respect the aspects of the system 100 of FIG. 1. However, the method 300 of FIG. 5 can be used with additional or alternative aspects in accordance with the aspects of the disclosure. The method 300 includes positioning at least a portion of at least one rail 108 to extend outside of the laboratory workstation 104 (302). In some examples, the at least one rail 108 may be positioned partially within the laboratory workstation 104 and partially outside the laboratory workstation 104. In some such aspects, the method 300 may further include positioning the at least one rail 108 within the laboratory workstation 104. As discussed above, in some aspects the at least one rail 108 may include a first portion 110 and a second portion 112 (e.g., as illustrated in FIG. 2B). In such aspects, the method 300 may include causing the second portion 112 to be oriented perpendicular to the first portion 110 and causing the second portion 112 to contact a support surface. In aspects in which the at least one rail 108 includes three portions (e.g., as illustrated in FIG. 2C), the method 300 may include causing the second portion 112 to substantially align with the first portion 110, causing the third portion 114 to be oriented perpendicular to the second portion 112, and causing the third portion 114 to contact a support surface.

The method 300 includes causing the actuator platform 106 to move the module 102 from the predetermined position within the laboratory workstation 104 and position the module 102 relative to the at least one rail 108 (304). In some aspects, causing the actuator platform 106 to move the module 102 from the predetermined position within the laboratory workstation 104 and position the module 102 relative to the at least one rail 108 includes causing the actuator platform 106 to raise the module 102 from the predetermined position. For example, the causing the actuator platform 106 to move the module 102 from the predetermined position may include causing the actuator platform 106 to raise the module 102 off of a mounting frame at the predetermined position. In some aspects, causing the actuator platform 106 to move the module 102 from the predetermined position may include rotating a screw mechanism of the actuator platform 106 (e.g., by manual rotation using a hand tool, by using a drill, by using a rotary motor) to cause the actuator platform 106 to raise and/or lower the actuator platform 106. Any other suitable mechanism may be used to raise or lower the actuator platform 106 (e.g., a linear motor, a pneumatic or hydraulic system).

The method 300 further includes transferring the module 102 from the actuator platform 106 to the at least one rail 108 (306). In some aspects, transferring the module 102 from the actuator platform 106 to the at least one rail 108 may include causing the actuator platform 106 to lower the module onto the at least one rail 108. In some aspects, transferring the module 102 from the actuator platform 106 to the at least one rail 108 may include rotating a screw mechanism of the actuator platform 106 (e.g., by manual rotation using a hand tool, by using a drill, by using a rotary motor) to lower the actuator platform 106. Any other suitable mechanism may be used to lower the actuator platform 106 (e.g., a linear motor, a pneumatic or hydraulic system). In other aspects, transferring the module 102 from the actuator platform 106 to the at least one rail 108 may include fastening the module 102 to the fastener 120 at the second position and moving the module 102 off of the actuator platform 106. In other aspects, transferring the module 102 from the actuator platform 106 to the at least one rail 108 may include additional or alternative steps.

The method 300 includes moving the module 102 from the second position within the laboratory workstation 104 to the first position at least partially outside the laboratory workstation 104 via the at least one rail 108 positioned within the laboratory workstation 104 (308). In some aspects, moving the module 102 from the second position to the first position via the at least one rail 108 positioned within the laboratory workstation 104 includes rolling the module 102 on the at least one rail 108 via at least one wheel coupled to the module 102. In other aspects, moving the module 102 from the second position to the first position includes sliding the module 102 along a surface of the at least one rail 108. In yet other aspects, moving the module 102 from the second position to a first position includes fastening the module 102 to a fastener 120 of the at least one rail 108 when the at least one rail 108 is in the collapsed configuration and extending the at least one rail 108 to the extended configuration. For example, the method 300 may include fastening the module to the fastener 120 at the second position when the at least one rail 108 is in the collapsed configuration and moving the at least one rail 108 from the collapsed configuration to the extended configuration to translate the module 102 from the second position to the first position. In some aspects, moving the module 102 from the second position to the first position may include a combination of the aspects described herein or may be moved from the second position to the first position in a different manner.

The method 300 further includes servicing the module 102. Servicing the module 102 may include any type of service, maintenance, repair, or the like. In some aspects, the module 102 may remain on or coupled to the at least one rail 108 during service of the module 102. In this way, servicing the module 102 may be more efficient, easier, and require less personnel than conventional systems including a module and a life sciences laboratory workstation.

The method 300 may include additional or alternative steps. For example, the method 300 may include steps described above with respect to the method 200 of FIG. 4. In some aspects, for example, the method 300 may include the steps described above with respect to method 200 to reinstall the module 102 at the predetermined position within the laboratory workstation 104 after servicing the module 102. Additionally, or alternatively, the method 300 may include storing one or both of the at least one rail 108 and/or the actuator platform 106. For example, the method 300 may include removing the at least one rail 108 from the laboratory workstation 104. In other aspects, the method 300 may include contracting the at least one rail 108 from an expanded configuration to a contracted storage configuration. In yet other aspects, one or more portions of the at least one rail 108 may be folded relative to another one or more portions of the at least one rail 108 for storage. Additionally, or alternatively, the method 300 may include moving the actuator platform 106 to a storage position. In some aspects, the actuator platform 106 remains in the laboratory workstation 104 when the actuator platform 106 is not in use.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1-79. (canceled)

80. A system for moving a module relative to a life sciences laboratory workstation, the system comprising:
the laboratory workstation;
at least one rail positioned at least partially within the laboratory workstation and extends outside of the laboratory workstation;
the module, wherein the module is configured to move from a first position at least partially outside of the laboratory workstation to a second position within the laboratory workstation via the at least one rail; and
an actuator platform within the laboratory workstation, wherein the actuator platform is configured to position the module at a predetermined position within the laboratory workstation.

81. The system of claim 80, wherein the at least one rail comprises:
a first portion; and
a second portion coupled to the first portion, wherein the second portion is configured to be oriented perpendicular to the first portion and to contact a support surface.

82. The system of claim 80, wherein module is configured to:
roll on the at least one rail via at least one wheel coupled to the module from the first position to the second position,
slide along a surface of the at least one rail from the first position to the second position, or
fasten to a fastener of the at least one rail when the at least one rail is in an extended configuration and translate from the first position to the second position when the at least one rail is moved from the extended configuration to a collapsed configuration.

83. The system of claim 80, wherein the actuator platform comprises a linear actuator configured to raise or lower the module.

84. The system of claim 83, wherein the actuator platform is configured to raise the module off the at least one rail.

85. The system of claim 80, wherein the at least one rail is removable from the laboratory workstation.

86. The system of claim 80, wherein the module is configured to be coupled to the laboratory workstation at the predetermined position.

87. The system of claim 80, wherein the actuator platform is configured to lower the module to the predetermined position.

88. The system of claim 86, wherein the module is configured to be coupled to a mounting frame of the laboratory workstation at the predetermined position.

89. The system of claim 80, wherein the actuator platform is configured to be positioned in a storage position under the module when the module is positioned in the laboratory workstation at the predetermined position.

90. The system of claim 80, wherein the at least one rail is configured to contract from an expanded configuration to a contracted storage configuration when the module is at the predetermined position.

91. The system of claim 80, wherein the actuator platform remains in the laboratory workstation when the actuator platform is not in use.

92-102. (canceled)

103. The system of claim 80, wherein the at least one rail comprises a first portion, a second portion, and a third portion.

104. The system of claim 103, wherein the first portion is coupled to the second portion via a first hinge mechanism and the second portion is coupled to the third portion via a second hinge mechanism.

105. (canceled)

106. A method of installing a module associated with a life sciences laboratory workstation, the method comprising:
positioning at least a portion of at least one rail to extend outside the laboratory workstation;
disposing the module on the at least one rail at a first position that is at least partially outside of the laboratory workstation;
moving the module from the first position to a second position within the laboratory workstation via the at least one rail positioned within the laboratory workstation;
transferring the module from the at least one rail to an actuator platform located within the laboratory workstation; and
causing the actuator platform to position the module at a predetermined position within the laboratory workstation.

107. A method of servicing a module associated with a life sciences laboratory workstation, the method comprising:
positioning at least a portion of at least one rail to extend outside the laboratory workstation;
causing an actuator platform located within the laboratory workstation to move the module from a predetermined position within the laboratory workstation and position the module relative to the at least one rail;
transferring the module from the actuator platform to the at least one rail;
moving the module from a first position within the laboratory workstation to a second position that is at least partially outside of the laboratory workstation via the at least one rail positioned within the laboratory workstation; and
servicing the module.
